(19) United States
(12) Patent Application Publication
(10) Pub. No.: US 2025/0364196 A1
(43) Pub. Date: Nov. 27, 2025

(54) A set of electrical switching contacts

(71) Applicant: Schneider Electric Industries SAS, Ruewil Malmaison (FR)

(72) Inventors: Anthony PAPILLON, Proveysieux (FR); Renaud CARLEN, La Tronche (FR); Jéröme DOUCHIN, Clain (FR)

(21) Appl. No.: 19/216,048

(22) Filed: May 22, 2025

(30) Foreign Application Priority Data
May 22, 2024 (FR) FR2405202

(51) Int. Cl. H01H 33/664; H01H 33/662

(52) U.S. Cl. CPC H01H 33/6643; H01H 33/66207

(57) ABSTRACT

A set (40) of electrical switching contacts (1, 2) for a vacuum breaker (100) is proposed, comprising:
a first contact (1),
a second contact (2) movable along an axis of movement (A),
each contact (1; 2) having the shape of a disc comprising a set of branches (5a, 5b, 5c; 6a, 6b, 6c) separated by a slot (7a, 7b, 7c; 8a, 8b, 8c) crossing the thickness of the disc,
in which each branch (5a, 5b, 5c) of the first contact (1) and each branch (6a, 6b, 6c) of the second contact (2) comprises an inclined surface (9a, 9b, 9c; 10a, 10b, 10c), and in which the first contact (1) and the second contact (2) are angularly linked so that:
the slots (7a, 7b, 7c) of the first contact (1) coincide with the slots (8a, 8b, 8c) of the second contact (2), and
the inclined surface (9a, 9b, 9c) of one branch (5a, 5b, 5c) of the first contact (1) and the inclined surface (10a, 10b, 10c) of one branch (6a, 6b, 6c) of the second contact (2) are opposite to each other.

### TECHNICAL FIELD

The present invention relates to the field of vacuum switching devices, also referred to as vacuum breakers. Vacuum breakers are used in low, medium and high voltage electrical distribution devices. Vacuum breakers are associated with actuators in order to switch the current in part of the circuit.

### PRIOR ART

As is well known, a vacuum breaker comprises two switching contacts positioned opposite each other. Each switching contact is rigidly connected to an electrical current conducting stem. The contacts are positioned in an envelope forming a sealed enclosure placed under vacuum. The contacts can be moved relative to each other by an actuation mechanism. When the contacts are pressing against each other, the current can pass from one contact to the other and can thus circulate in the vacuum breaker. When the contacts are separated from each other, the current is interrupted in the vacuum breaker.

When the current is interrupted and when the current is established, an electrical arc forms between the contacts. If it remains stationary, this electrical arc can generate sufficient heat to melt the surface of the contacts locally, which damages them. It is thus known practice to give the contacts a shape such that the electrical arc formed generates a radial magnetic field that causes the electrical arc to circulate on the contact. Stagnation of the arc in a fixed area of the contact is thus prevented. The circulation of the electrical arc in the contact tends to make the heating uniform, and makes it possible to reduce local damage. It is desirable for the shape of the contacts to also generate an orthoradial magnetic force on the electrical arc, that is, perpendicular to the direction radial to the contact, in order to cause this electrical arc to rotate in the contact. To this end, each contact can comprise a series of through-slots. The slots of one contact are positioned opposite to the slots of the other contact so as to generate a current loop, which allows satisfactory circulation of the electrical arc. The current switching performance can be optimized by adjusting the shape of the slots of the contacts, and their relative position.

The present invention aims to improve the performance of this type of vacuum breaker.

### SUMMARY

To this end, the invention proposes a set of electrical switching contacts, in particular radial magnetic field contacts, for a vacuum breaker, the set comprising:
a first contact comprising a bearing surface configured to be fastened to a first electrical current conducting stem,
a second contact configured to be moved along an axis of movement between an open position and a closed position, the second contact comprising a bearing surface configured to be fastened to a second electrical current conducting stem,
each contact having the shape of a disc comprising a set of branches, each branch being separated from an adjacent branch by a slot crossing the thickness of the disc, each slot extending radially from the periphery of the disc towards the inside of the disc, in which:
each branch of the first contact comprises an inclined surface oriented in the opposite direction to the bearing surface of the first stem,
each branch of the second contact comprises an inclined surface oriented in the opposite direction to the bearing surface of the second stem,
and in which the first contact and the second contact are angularly linked so that:
the slots of the first contact coincide with the slots of the second contact along a direction parallel to the axis of movement, and
the inclined surfaces of the branches of the first contact and the inclined surfaces of the branches of the second contact are opposite to each other along a direction parallel to the axis of movement.

The electrical contact formed on the opening of the contacts moves along the branches of the contacts, under the effect of the magnetic field generated by the passage of the current in the contacts and in the electrical arc.

When the electrical arc is near the periphery of the contacts, the electrical arc is positioned between a point of an inclined surface of one contact and a point of an inclined surface of the other contact, situated opposite to it. The electrical arc moves along the inclined surfaces. When the electrical arc reaches the end of the inclined surfaces, the electrical arc can easily move onto the next branch of each contact. The proposed configuration makes it possible to prevent the stagnation of the electrical arc at the end of a branch, and promotes the circulation of the electrical arc. The heating of the contacts is reduced, and the performance and endurance of the vacuum breaker are improved.

The features listed in the following paragraphs can be implemented independently of one another or in any technically possible combination.

Each inclined surface of the first contact respectively extends, in a radial direction, between the periphery of the disc and a slot of the first contact.

According to one aspect of the set of electrical switching contacts, each branch of the first contact respectively comprises a first end adjacent to the lateral surface of the disc, and the first end of each branch is respectively opposite to an edge of an adjacent branch along a direction parallel to the axis of movement.

This relative positioning of the inclined surface of a given branch and the edge of the branch adjacent to this given branch promotes the circulation of the electrical arc, by allowing easy movement of the electrical arc from one branch to another.

The first end of a branch is the free end of the branch.

According to one aspect of the set of electrical switching contacts, the first contact and the second contact are symmetrical to each other relative to a plane perpendicular to the axis of movement.

According to one exemplary embodiment, the first contact and the second contact comprise three branches angularly offset from each other by 120°.

According to another exemplary embodiment, the first contact and the second contact comprise four branches angularly offset from each other by 90°.

According to yet another exemplary embodiment, the first contact and the second contact comprise five branches angularly offset from each other by 72°.

According to one embodiment, the inclined surface of each branch of the first contact is flat.

According to another embodiment, the inclined surface of each branch of the first contact is a curved surface.

The inclined surface of each branch of the first contact is for example a helical surface.

According to one exemplary embodiment of the set of electrical switching contacts, a straight line perpendicular to the inclined surface of each branch of the first contact respectively forms an angle of between 10° and 80° with a direction parallel to the axis of movement, preferably between 20° and 60°, more preferably between 25° and 40°.

This value of the angle of inclination promotes the circulation of the electrical arc and ease of jumping between one branch of the contacts and the adjacent branch.

The inclined surface of each branch of the first contact respectively forms an angle of between 20° and 160° with the inclined surface of the branch of the second contact situated opposite to it. Preferably, this angle is between 40° and 120°, and more preferably, this angle is between 50° and 80°.

According to one embodiment of the set of electrical switching contacts, the first end of each branch of the first contact has the shape of a semi-cylinder extending along an axis parallel to the axis of movement.

According to another embodiment of the set of electrical switching contacts, the inclined surface of each branch of the first contact is respectively extended by a portion of constant thickness.

The portion of constant thickness extends in a plane perpendicular to the axis of movement.

The thickness of the portion of constant thickness is between 10% and 90% of the thickness of the first contact.

Each portion of constant thickness of a branch respectively extends from one lateral edge to the other lateral edge of the branch.

A length, measured along an orthoradial direction, of the portion of constant thickness of a branch, is between 2.0 millimetres and 8.0 millimetres.

According to one aspect of the set of electrical switching contacts, the inclined surface of each branch of the first contact is respectively opposite to an inner surface of an adjacent branch, referred to as the interface surface, along a direction parallel to an orthoradial direction of the disc.

The inner surface, referred to as the interface surface, emerges in the lateral surface of the disc.

According to one embodiment, the interface surface of each branch adjacent to a given branch of the first contact respectively comprises an inclined surface extending parallel to the inclined surface of said given branch.

According to one embodiment of the set of contacts:
the inclined surface of each branch of the first contact extends from a first axial surface of the disc to a second axial surface of the disc, and
the inclined surface of the interface surface of a branch adjacent to a given branch extends from a first axial surface of the disc to a second axial surface of the disc.

According to one particular exemplary embodiment, the inclined surface of each branch of the first contact and the inclined surface of the interface surface of each branch adjacent to a given branch are parallel to each other.

According to this embodiment of the set of electrical contacts, the interface surface of each branch adjacent to a given branch respectively comprises a portion extending in a plane parallel to the axis of movement, each of said portions respectively extending the inclined surface.

According to another embodiment, the interface surface of each branch adjacent to a given branch respectively comprises a first portion extending in a plane parallel to the axis of movement.

Each plane of extension of the first portion can form a radial plane of the disc.

According to one variant embodiment, each plane of extension of the first portion can respectively be parallel to a radial plane of the disc, and the distance between each plane of extension of the first portion and the centre of the disc is less than 10% of the diameter of the disc.

The thickness of each first portion of the interface surface is between 10% and 50% of the thickness of the first contact.

According to this embodiment, the interface surface of each branch adjacent to a given branch respectively comprises a second portion extending in a plane parallel to the axis of movement.

Each plane of extension of the second portion is respectively parallel to the plane of extension of the first portion.

The thickness of each second portion of the interface surface can be between 50% and 90% of the thickness of the first contact.

A distance, measured along an orthoradial direction, between the first portion of the interface surface and the second portion of the interface surface, is between 30% and 60% of the thickness of the first contact.

The length, measured along an orthoradial direction, of the third portion is between 30% and 60% of the thickness of the first contact.

A distance, measured along a direction parallel to the axis of movement, between the portion of constant thickness of a branch and the first portion of the interface surface of an adjacent branch, is between 25% and 65% of the thickness of the first contact.

The distance is greater than or equal to 3 millimetres.

According to this embodiment of the set of electrical contacts, the interface surface of each branch adjacent to a given branch respectively comprises a third portion connecting the second portion and the first portion, the third portion extending in a plane perpendicular to the axis of movement.

The invention also relates to a vacuum breaker comprising a set of contacts as described above, the second contact being movable between a position in contact with the first contact that allows the passage of electrical current in the vacuum breaker and a position separated from the first contact that prohibits the passage of current in the vacuum breaker.

The invention also relates to a vacuum breaker comprising a set of contacts as described above, the two contacts being configured to be moved in opposite directions along an axis of movement between a closed position that allows the passage of electrical current in the vacuum breaker and an open position that prohibits the passage of current in the vacuum breaker.

The invention also relates to a switching device comprising a vacuum breaker as described above.

The invention also relates to a method for manufacturing a contact of a set of electrical switching contacts as described above.

The manufacturing method comprises the steps of:
providing a blank contact having the shape of a disc comprising a first axial face and a second axial face on the opposite side from the first axial face,
machining the first axial face of the blank contact so as to form a set of first grooves at least partially crossing the thickness of the blank contact,
machining the second axial face of the blank contact so as to form a set of second grooves at least partially crossing the thickness of the blank contact and emerging in the first grooves, so as to form the slots separating the different branches of the contact.

On the machining of the set of first slots, the lateral surface of the machining tool forms, during the movement thereof, the first portion of the branches. The axial surface of the machining tool forms, during the movement thereof, the portion of constant thickness.

On the machining of the set of second slots, the lateral surface of the machining tool forms, during the movement thereof, the second portion and the end of the branches. The axial surface of the machining tool forms, during the movement thereof, the third portion.

The manufacturing method comprises the step of:
machining the first axial face of the blank contact so as to form the inclined surfaces of the branches of the contact.

The inclined surfaces are formed by successive passes of the machining tool.

According to one embodiment, the manufacturing method can comprise the step of:
machining part of the lateral surface of the blank contact so as to form the inclined surfaces of the branches of the contact.

### BRIEF DESCRIPTION OF THE DRAWINGS

Further features, details and advantages will become apparent on reading the detailed description below, and on studying the appended drawings, in which:

FIG. 1 is a schematic depiction of a vacuum breaker according to the prior art,

FIG. 2 is a side view of a set of electrical switching contacts according to a first embodiment of the invention,

FIG. 3 is a perspective view of an electrical switching contact of the set in FIG. 2,

FIG. 4 is a perspective view of an electrical switching contact according to a variant of the first embodiment,

FIG. 5 is a side view of a set of electrical switching contacts according to a second embodiment of the invention,

FIG. 6 is a perspective view of an electrical switching contact of the set in FIG. 5,

FIG. 7 is another perspective view of an electrical switching contact of the set in FIG. 5,

FIG. 8 is a top view of an electrical switching contact of the set in FIG. 5,

FIG. 9 is a bottom view of an electrical switching contact of the set in FIG. 5,

FIG. 10 is a detailed perspective view of an electrical switching contact of the set in FIG. 5,

FIG. 11 is another detailed perspective view of an electrical switching contact of the set in FIG. 5,

FIG. 12 is a perspective view of an electrical switching contact according to a variant of the second embodiment,

FIG. 13 is a top view of the electrical switching contact in FIG. 11,

FIG. 14 is a schematic side view of a set of electrical switching contacts according to a third embodiment.

### DESCRIPTION OF THE EMBODIMENTS

In order to make the figures easier to read, the various elements are not necessarily shown to scale. In these figures, identical elements bear the same reference signs. Some elements or parameters can be given ordinal numbers, in other words designated for example first element or second element, or first parameter and second parameter, etc. The purpose of this ordinal numbering is to make a distinction between elements or parameters that are similar but not identical. This ordinal numbering does not imply any priority of one element, or parameter, over another and the designations can be interchanged. When it is specified that a sub-system comprises a given element, this does not rule out the presence of other elements in this sub-system.

In the various figures, the axes X, Y, Z denote the three directions of space in order to identify the viewing angle of each figure.

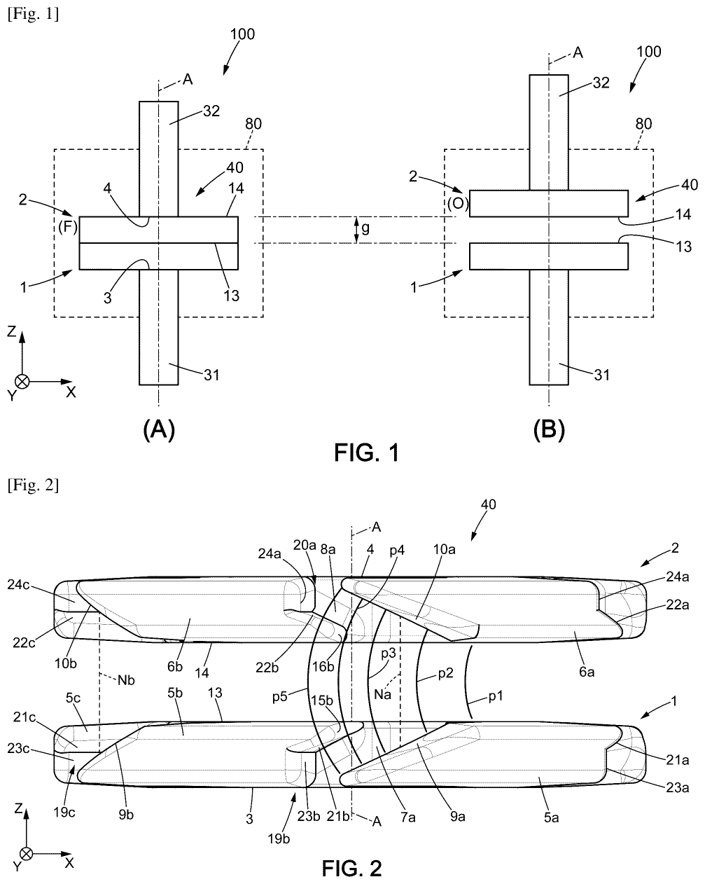

FIG. 1 shows a vacuum breaker 100 comprising a set 40 of electrical switching contacts 1, 2, which will be described in detail below.

A switching device, not shown, comprises the vacuum breaker 100.

The switching device is for example a medium voltage or high voltage device.

The switching device can be for example a circuit breaker, a disconnector or a switch.

According to the example illustrated, the switching device comprises three electrical conductors respectively corresponding to a phase, and each electrical conductor comprises a vacuum breaker 100.

The vacuum breaker 100 comprises an envelope 80, forming a sealed enclosure under vacuum. This is given to mean that the pressure prevailing inside the envelope is less than 10⁻⁴ millibar. A shield, not shown, is positioned facing the switching contacts 1, 2 along a radial direction, and protects the envelope 80 from deposits of metal detached from the contacts 1, 2.

The set 40 of electrical switching contacts 1, 2 is positioned in the enclosure 80.

The first contact 1 is rigidly connected to a first electrical current conducting stem 31.

The second contact 2 is rigidly connected to a second electrical current conducting stem 32.

The second contact 2 is movable between:
a position F in contact with the first contact 1 that allows the passage of electrical current in the vacuum breaker 100, and
a position O separated from the first contact 1 that prohibits the passage of current in the vacuum breaker 100.

The first contact 1 comprises a contact surface 13 configured to come into contact with the second contact 2.

Likewise, the second contact 2 comprises a contact surface 14 configured to come into contact with the first contact 1.

When the contacts 1, 2 are in the closed position F, the contact surface 13 of the first contact 1 is bearing against the contact surface 14 of the second contact 2. This operating scenario is schematically illustrated in part A of FIG. 1, and corresponds to the closing of the electrical circuit. The electrical current can thus circulate between the first conducting stem 31 and the second conducting stem 32, passing through the contacts 1, 2.

When the contacts 1, 2 are in the open position O, the contact surface 13 of the first contact 1 is spaced apart from the contact surface 14 of the second contact 2. The two contacts 1, 2 are separated from each other. This operating scenario is illustrated in part B of FIG. 1, and corresponds to the opening of the electrical circuit.

The arrow denoted by reference sign g depicts the separation distance between the two contacts 1, 2 when they are in the open position O.

A control mechanism, not shown, makes it possible to move the two contacts 1, 2 relative to each other in order to alternate between the closed position F and the open position O of the electrical circuit.

The first contact 1 is for example fixed relative to the enclosure 80 of the vacuum breaker 100.

The second contact 2 is for example movable relative to the enclosure 80 of the vacuum breaker, in a translational movement.

According to one variant embodiment, the contacts 1, 2 can both be movable. In this case, the two contacts 1, 2 of the vacuum breaker 100 are configured to be moved in opposite directions along an axis of movement A between a closed position F and an open position O.

The closed position F allows the passage of electrical current in the vacuum breaker 100, and the closed position O prohibits the passage of current in the vacuum breaker 100.

A control mechanism can jointly move each of the contacts 1, 2 relative to the enclosure 80 of the vacuum breaker 100.

The axis of movement A is common to the two contacts 1, 2.

The first conducting stem 31 and the second conducting stem 32 are cylindrical.

The first contact 1 and the first conducting stem 31 are coaxial.

Likewise, the second contact 2 and the second conducting stem 32 are coaxial.

The first electrical current conducting stem 31 and the second electrical current conducting stem 32 are thus coaxial, on the axis A in the various figures.

The axis of movement of the second contact 2 coincides with the axis A of the second current conducting stem 32.

In the various figures, the contacts 1, 2 are oriented so that the axis of movement of the second contact 2 is parallel to the vertical axis Z. The contacts can however have any spatial orientation.

Each contact 1, 2 extends radially in a plane perpendicular to the axis of movement A. The distance of radial extension of each contact 1, 2 defines the diameter fi of each contact.

Each contact 1, 2 extends axially in the direction of the axis A. The distance of axial extension of each contact defines the thickness E of each contact.

The contact surface 13 of the first contact 1 extends in a plane perpendicular to the axis of the current conducting stem 31 of the first contact 1. Likewise, the contact surface 14 of the second contact 2 extends in a plane perpendicular to the axis of the current conducting stem 32 of the second contact 2.

The first contact 1 is made from an alloy of copper and chromium.

The second contact 2 is made from an alloy of copper and chromium.

Here, each contact 1, 2 is in one piece.

The present invention proposes a set 40 of electrical switching contacts 1, 2, in particular radial magnetic field contacts, for a vacuum breaker 100.

The set 40 comprises:
a first contact 1 comprising a bearing surface 3 configured to be fastened to a first electrical current conducting stem 31,
a second contact 2 configured to be moved along an axis of movement A between an open position O and a closed position F, the second contact 2 comprising a bearing surface 4 configured to be fastened to a second electrical current conducting stem 32. Each contact 1, 2 has the shape of a disc comprising a set of branches 5a, 5b, 5c; 6a, 6b, 6c, each branch 5a, 5b, 5c; 6a, 6b, 6c being separated from an adjacent branch by a slot 7a, 7b, 7c; 8a, 8b, 8c crossing the thickness of the disc.

Each slot 7a, 7b, 7c; 8a, 8b, 8c extends radially from a lateral surface 33, 34 of the disc towards the inside of the disc, and:
each branch 5a, 5b, 5c of the first contact 1 comprises an inclined surface 9a, 9b, 9c oriented in the opposite direction to the bearing surface 3 of the first stem 31,
each branch 6a, 6b, 6c of the second contact 2 comprises an inclined surface 10a, 10b, 10c oriented in the opposite direction to the bearing surface 4 of the second stem 32,
and the first contact 1 and the second contact 2 are angularly linked so that:
the slots 7a, 7b, 7c of the first contact 1 coincide with the slots 8a, 8b, 8c of the second contact 2 along a direction parallel to the axis of movement A, and
the inclined surfaces 9a, 9b, 9c of the branches 5a, 5b, 5c of the first contact 1 and the inclined surfaces 10a, 10b, 10c of the branches 6a, 6b, 6c of the second contact 2 are opposite to each other along a direction parallel to the axis of movement A.

FIG. 2 shows the set 40 of switching contacts 1, 2 separated from each other. The curved lines denoted by reference signs p1, p2, . . . , p5 schematically show the successive positions of the electrical arc formed on the opening of the contacts 1, 2. According to the viewing angle in FIG. 2, the electrical arc moves from right to left along the branches of the contacts 1, 2, under the effect of the magnetic field generated by the passage of the current in the contacts 1, 2 and in the electrical arc.

When the electrical arc is near the periphery of the contacts, the electrical arc occurs between a point of an inclined surface of the first contact 1 and a point of an inclined surface of the second contact 2, situated opposite to it. The electrical arc moves along the inclined surface of each contact, as schematically shown by reference signs p2, p3, p4.

When the electrical arc reaches the end of the inclined surface of a branch of a contact, the electrical arc can easily move onto the next branch of this contact. This movement onto the next branch of the contacts is schematically shown by reference sign p5.

The proposed configuration makes it possible to prevent the stagnation of the electrical arc at the end of the branches of the contacts 1, 2, and promotes the circulation of the electrical arc. The heating of the contacts 1, 2 is reduced. The performance and endurance of the vacuum breaker are improved.

Each slot of the first contact 1 coincides with a slot of the second contact 2 along a direction parallel to the axis of movement A. Likewise, each slot of the second contact 2 coincides with a slot of the first contact 1 along a direction parallel to the axis of movement A.

In other words, the slots of the first contact 1 and the slots of the second contact 2 are opposite to each other along a direction parallel to the axis A.

Within the meaning of the present application, there can be a certain degree of angular offset between the slots of the first contact 1 and the slots of the second contact 2. This is because, during the assembly of a contact and the corresponding conducting stem, minimal positioning errors are inevitable.

An angular offset of up to ±10° is thus considered to be acceptable. This angular offset is viewed along a direction parallel to the direction of movement A.

A straight line starting from a point positioned on the central line of a slot of the first contact 1, and parallel to the axis of movement A, passes through a slot of the second contact 2. Central line is given to mean the virtual line situated equidistant from the lateral edges of a slot.

A straight line stating from an inclined surface 9a, 9b, 9c of a branch 5a, 5b, 5c of the first contact 1, and parallel to the axis of movement A, respectively passes through an inclined surface 10a, 10b, 10c of a branch 6a, 6b, 6c of the second contact 2.

In FIG. 2, the straight line starting from the inclined surface 9a of the branch 5a of the first contact 1, parallel to the axis of movement A and passing through the inclined surface 10a of the branch 6a of the second contact 2, is denoted by reference sign Na. Likewise, the straight line starting from the inclined surface 9b of the branch 5b of the first contact 1, parallel to the axis of movement A and passing through the inclined surface 10b of the branch 6b of the second contact 2, is denoted by reference sign Nb. In order to simplify the figure, this straight line is not shown for the other branches of the contacts 1, 2.

In other words, each slot 7a, 7b, 7c of the first contact 1 respectively coincides with a slot 8a, 8b, 8c of the second contact 2 along a direction parallel to the axis of movement A, and
the inclined surface 9a, 9b, 9c of each branch 5a, 5b, 5c of the first contact 1 and the inclined surface 10a, 10b, 10c of each branch 6a, 6b, 6c of the second contact 2 are respectively opposite to each other along a direction parallel to the axis of movement A.

On a radially inner portion, each slot 7a, 7b, 7c; 8a, 8b, 8c crosses the thickness of the disc along a direction parallel to the axis of movement A.

The first contact 1 and the second contact 2 can have any number of branches, generally between two and eight.

The branches of the contacts 1, 2 are evenly angularly distributed, that is, two consecutive branches are separated by an angle equal to 360° divided by the number of branches. This angular separation is viewed along a direction parallel to the axis A of the current conducting stem.

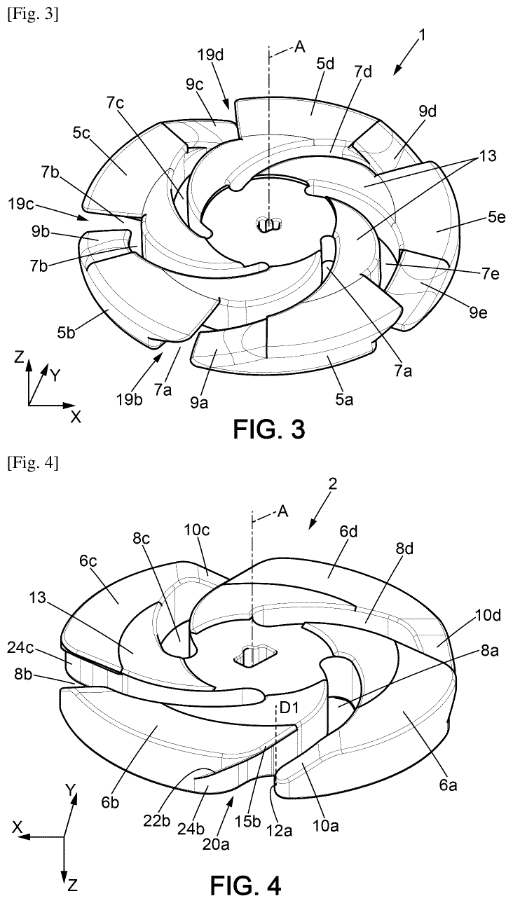

According to a first embodiment, illustrated in FIGS. 2 and 3, the first contact 1 and the second contact 2 comprise five branches 5a, 5b, 5c, 5d, 5e angularly offset from each other by 72°.

In this case, the first contact 1 and the second contact 2 have a symmetry of order 5.

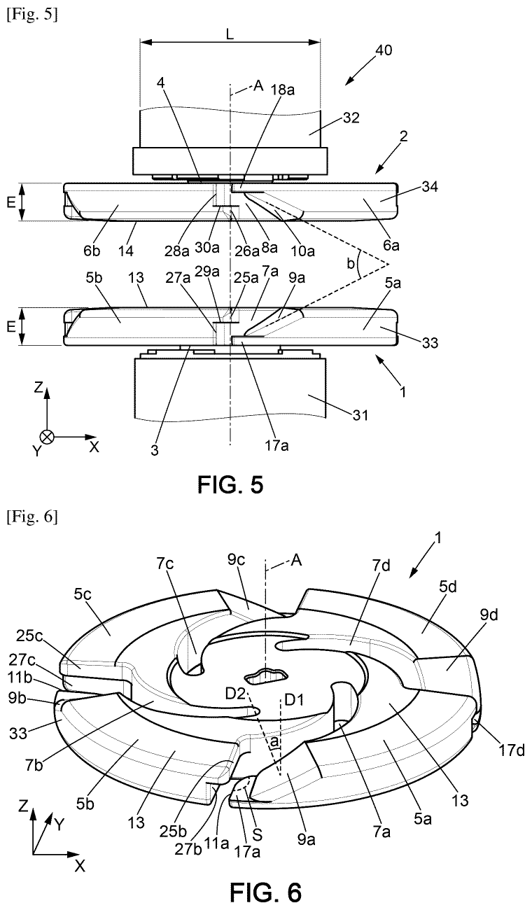

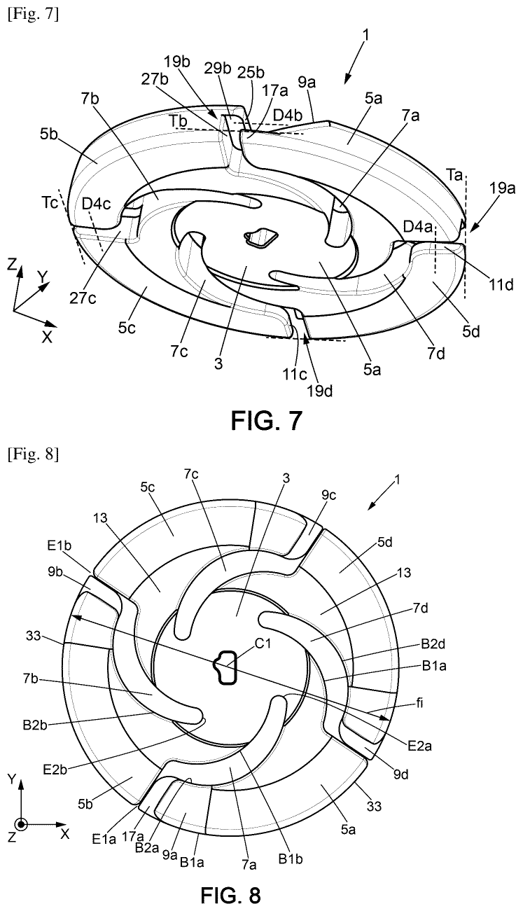

According to a second embodiment, illustrated in particular in FIGS. 5 to 9, the first contact 1 and the second contact 2 comprise four branches 5a, 5b, 5c, 5d, angularly offset from each other by 90°.

The first contact 1 and the second contact 2 therefore have a symmetry of order 4, that is, each contact is invariant by a rotation of one quarter of a turn.

According to one exemplary embodiment, not illustrated, the first contact 1 and the second contact 2 comprise three branches 5a, 5b, 5c angularly offset from each other by 120°.

The first contact 1 and the second contact 2 therefore have a symmetry of order 3, that is, each contact is invariant by a rotation of one third of a turn.

A slot separates two consecutive branches.

Each branch is delimited by two consecutive slots. In other words, a branch is formed by the material contained between two consecutive slots.

In the case of a contact comprising four branches and four slots, illustrated in particular in FIGS. 5 to 9, the first branch 5a is delimited on one side by the fourth slot 7d and on the other side by the first slot 7a.

As shown in FIG. 8, the fourth slot 7d forms a radially outer first lateral edge B1a of the first branch 5a. The first slot 7a forms a radially inner second lateral edge B2a of the first branch 5a.

The second branch 5b is delimited on one side by the first slot 7a and on the other side by the second slot 7b.

The first slot 7a thus forms a radially outer first lateral edge B1b of the second branch 5b. The second slot 7b forms a radially inner second lateral edge B2b of the second branch 5b.

Likewise, the third branch 5c is delimited on one side by the second slot 7b and on the other side by the third slot 7c.

The second slot 7b forms a radially outer first lateral edge of the third branch 5c. The third slot 7c forms a radially inner second lateral edge of the third branch 5c.

Likewise, the fourth branch 5d is delimited on one side by the third slot 7c and on the other side by the fourth slot 7d.

The third slot 7c forms a radially outer first lateral edge of the fourth branch 5d. The fourth slot 7d forms a radially inner second lateral edge B2d of the fourth branch 5d.

Each slot extends between a first end emerging on the periphery of the disc and a second end forming a bottom of the slot.

Reference signs E2a, E2b respectively denote the bottom of the first slot 7a and of the second slot 7b.

Reference signs E1a, E1b respectively denote the end of the first slot 7a emerging on the periphery of the disc and the end of the second slot 7b emerging on the periphery of the disc.

The bottoms of the slots can be semi-circular.

The width of the slots is constant over at least part of the length thereof.

Each slot comprises a first portion extending radially in a spiral shape from the bottom of the slot towards the periphery of the disc.

The first spiral portion is extended by a second portion extending in a substantially radial direction.

The joining zone between the first portion and the second portion forms a change in direction that is close to 90°.

The bearing surface 3 of the first contact 1 is a surface for soldering the first electrical current conducting stem 31.

Likewise, the bearing surface 4 of the second contact 2 is a surface for soldering the second electrical current conducting stem 32.

A soldering material is positioned between an axial end of the first current conducting stem 31 and the bearing surface 3 of the first contact 1.

Likewise, the soldering material is positioned between an axial end of the second current conducting stem 32 and the bearing surface 4 of the second contact 2.

A geometric singularity positioned at one end of each current conducting stem is inserted into a complementary geometric singularity of the corresponding contact. Predetermined relative angular positioning can thus be ensured between each current conducting stem and the corresponding contact.

Each inclined surface 9a, 9b, 9c of the first contact 1 respectively extends, in a radial direction, between the periphery P1 of the disc and a slot 7a, 7b, 7c of the first contact 1.

Each inclined surface 9a, 9b, 9c emerges in the lateral surface 33 of the first contact 1.

In other words, a radially outer edge of each inclined surface 9a, 9b, 9c respectively forms the intersection of this inclined surface 9a, 9b, 9c and the lateral surface 33 of the first contact 1.

Each inclined surface 9a, 9b, 9c also emerges in a slot 7a, 7b, 7c of the first contact 1. A radially inner edge of each inclined surface 9a, 9b, 9c thus respectively forms the intersection of this inclined surface 9a, 9b, 9c and the slot 7a, 7b, 7c of the first contact 1.

In other words, each inclined surface is delimited on a radially outer side by the periphery of the first contact 1, and on a radially inner side by a slot.

The term radially outer, or outside, is given to mean the edge furthest from the centre of the disc. Likewise, the term radially inner, or inside, is given to mean the edge closest to the centre of the disc.

The periphery of the first contact 1 coincides with the periphery of the disc providing the general shape of the contact.

The inclined surface 9a, 9b, 9c of each branch 5a, 5b, 5c of the first contact 1 is oriented towards the contact surface 13 of the first contact 1.

The inclined surface 9a, 9b, 9c of each branch 5a, 5b, 5c of the first contact 1 is thus oriented in the opposite direction to the bearing surface 3, to which the stem 31 is soldered.

The inclined surface 9a, 9b, 9c of each branch 5a, 5b, 5c defines a portion of decreasing thickness as it moves away from the contact surface 13 of the first contact 1 and towards the bearing surface 3.

This thickness is measured parallel to the axis A of the current conducting stem 31 associated with the first contact 1.

In FIG. 10, reference sign e1 illustrates the thickness of the portion of the first branch 5a contained under the inclined surface 9a, for a first position separated from the contact surface 13. Reference sign e2 illustrates the thickness of the portion contained under the inclined surface 9a for a second position further from the contact surface 13 than the first position. The thickness e2 is less than the thickness e1.

Each branch 5a, 5b, 5c of the first contact 1 respectively comprises a first end 11a, 11b, 11c adjacent to the lateral surface 33 of the disc, and the first end 11a, 11b, 11c of each branch 5a, 5b, 5c is respectively opposite to an edge 15a, 15b, 15c of an adjacent branch 5b, 5c, 5a along a direction D3 parallel to the axis of movement A.

“Opposite to” is given to mean with an offset of less than 0.4 millimetre, this offset being measured along a direction perpendicular to the direction D3.

Due to the manufacturing tolerances and the mechanical clearances necessary to allow the assembly of the contacts with their conducting stems, slight offsets can be present, and the “opposite” position can be confirmed to within a tolerance.

An offset of 0.4 millimetre measured on the periphery of the disc represents an angular offset of less than 0.7° in the case of a contact with a diameter of 70 millimetres. This angular offset corresponds to the angle between the direction connecting the first end 11a, 11b, 11c of a branch 5a, 5b, 5c to the centre of the disc, and the direction connecting the edge 15a, 15b, 15c of the adjacent branch 5b, 5c, 5a, this angle being viewed from a viewing angle identical to that in FIGS. 8, 9, 13.

In other words, an end 11a, 11b, 11c of a given branch 5a, 5b, 5c is respectively aligned, along a direction D1 parallel to the axis of movement A, with the edge 15a, 15b, 15c of the branch adjacent to this given branch 5a, 5b, 5c.

This relative positioning of the inclined surface of a given branch and the edge of the branch adjacent to this given branch promotes the circulation of the electrical arc, by allowing easy movement of the electrical arc from one branch to another.

The first end 11a, 11b, 11c of a branch 5a, 5b, 5c is the free end of the branch 5a, 5b, 5c.

In the example illustrated, the first contact 1 and the second contact 2 are symmetrical to each other relative to a plane perpendicular to the axis of movement A. The first contact 1 and the second contact 2 are the mirror image of each other.

All of the features of the first contact 1 are also applicable to the second contact 2.

The features of the second contact 2 are thus not explicitly listed in the following description. They are obtained by replacing the term “first contact 1” with “second contact 2”.

According to the example illustrated, the inclined surface 9a, 9b, 9c of each branch 5a, 5b, 5c of the first contact 1 is a curved surface.

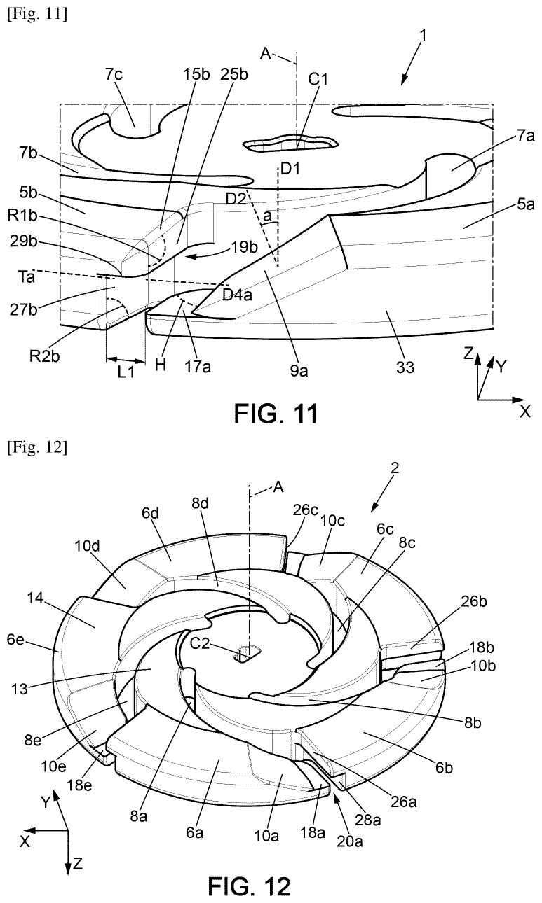

The inclined surface 9a, 9b, 9c of each branch 5a, 5b, 5c of the first contact 1 is for example a helical surface. FIGS. 10 and 11 show particular details of the inclined surface 9a of a branch 5a.

According to one variant embodiment, not shown, the inclined surface 9a, 9b, 9c of each branch 5a, 5b, 5c of the first contact 1 is flat.

FIG. 6 shows the inclination of the inclined surfaces 9a, 9b, 9c.

A straight line D2 perpendicular to the inclined surface 9a, 9b, 9c of each branch 5a, 5b, 5c of the first contact 1 respectively forms an angle a of between 10° and 80° with a direction D1 parallel to the axis of movement A.

Preferably, the angle a is between 20° and 60°. More preferably, the angle a is between 25° and 40°.

This value of the angle of inclination promotes the circulation of the electrical arc and ease of jumping between a given branch of the contact and the branch adjacent to this given branch.

FIG. 5 is another illustration of the inclination of the inclined surfaces 9a, 9b, 9c.

The inclined surface 9a, 9b, 9c of each branch 5a, 5b, 5c of the first contact 1 respectively forms an angle b of between 20° and 160° with the inclined surface 10a, 10b, 10c of the branch 6a, 6b, 6c of the second contact 2 situated opposite to it.

Preferably, the angle b is between 40° and 120°.

More preferably, the angle b is between 50° and 80°.

The end of the branches of the contacts 1, 2 can have different shapes.

According to a first embodiment, illustrated in FIG. 2 and FIG. 3, the first end 11a, 11b, 11c of each branch 5a, 5b, 5c of the first contact 1 comprises a substantially straight edge. The substantially straight edge extends along a radial direction of the disc.

According to one variant of the first embodiment, the first end 11a, 11b, 11c of each branch 5a, 5b, 5c of the first contact 1 has the shape of a semi-cylinder extending along an axis parallel to the axis of movement A.

This variant embodiment is illustrated in FIG. 4, which shows a second contact 2.

According to second embodiment of the set 40 of electrical switching contacts 1, 2, illustrated in FIGS. 5 to 11, the inclined surface 9a, 9b, 9c of each branch 5a, 5b, 5c of the first contact 1 is respectively extended by a portion 17a, 17b, 17c of constant thickness.

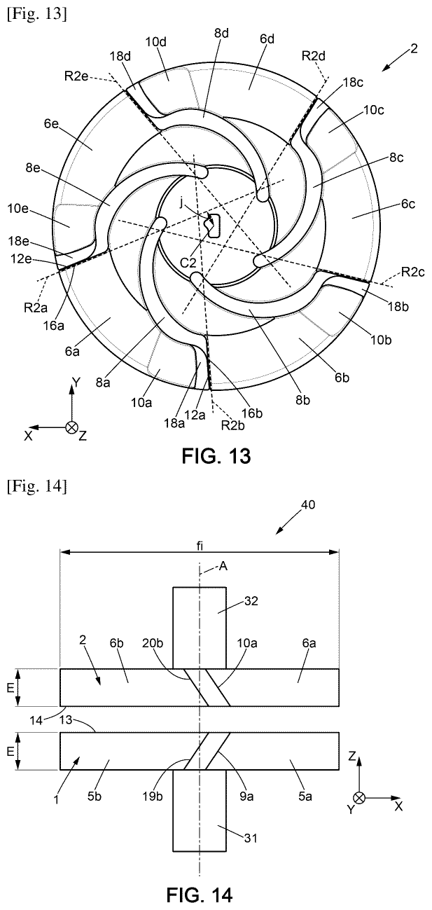

The same applies to the variant of the second embodiment illustrated in FIGS. 12 and 13. FIGS. 12 and 13 show the second contact 2.

This variant differs from the second embodiment in the number of branches, of which there are five in the variant.

Reference signs 10a, 10b, 10c, 10d, 10e denote the respective inclined surfaces of the five branches 6a, 6b, 6c, 6d, 6e of the second contact 2. Likewise, reference signs 8a, 8b, 8c, 8d, 8e denote the slots separating the branches.

Reference signs 18a, 18b, 18c, 18d, 18e respectively denote the portion of constant thickness of the branches 8a, 8b, 8c, 8d, 8e.

Reference signs 12a and 12e denote the respective ends of the branches 8a and 8e.

Reference signs 16a, 16b denote the respective edges of the branches 6a, 6b.

Reference sign 28a denotes the second portion of the branch 6b of the second contact 2.

As shown in FIGS. 10 and 11, the portion 17a, 17b, 17c of constant thickness extends in a plane H perpendicular to the axis of movement A.

The first contact 1 has a thickness E, defined by the distance separating a first axial surface of the contact 1 and a second axial surface of the contact 1.

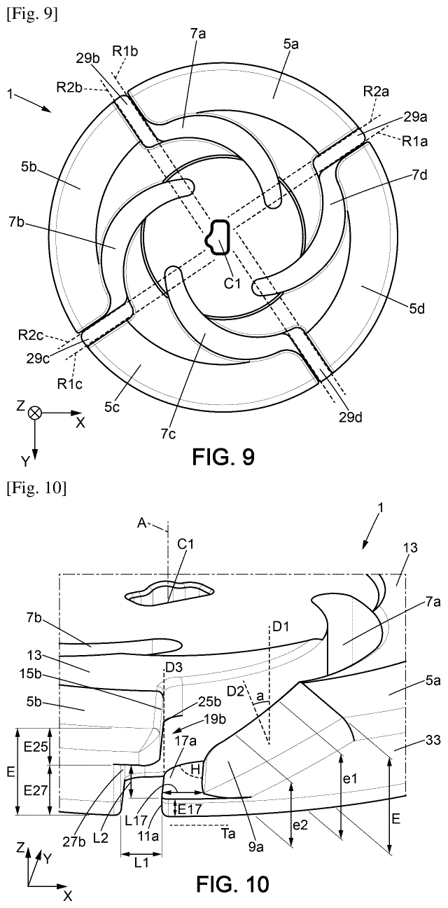

The thickness E17 of the portion 17a, 17b, 17c of constant thickness is between 10% and 90% of the thickness E of the first contact 1. This thickness E17 is visible in FIG. 9.

Each portion 17a, 17b, 17c of constant thickness of a branch 5a, 5b, 5c respectively extends from one lateral edge to the other lateral edge of the branch 5a, 5b, 5c.

A length L17, measured along an orthoradial direction Ta, Tb, Tc, of the portion 17a, 17b, 17c of constant thickness of a branch 5a, 5b, 5c is between 2.0 millimetres and 8.0 millimetres.

Orthoradial direction at a point is given to mean a direction parallel to the tangent to the disc at this point.

The inclined surface 9a, 9b, 9c of each branch 5a, 5b, 5c of the first contact 1 is respectively opposite to an inner surface 19b, 19c, 19a of an adjacent branch 5b, 5c, 5a, referred to as the interface surface, along a direction D4a, D4b, D4c parallel to an orthoradial direction Ta, Tb, Tc of the disc.

The inner surface 19b, 19c, 19a, referred to as the interface surface, emerges in the lateral surface 33 of the disc.

The inner surface 19b, 19c, 19a, referred to as the interface surface, is respectively separated from the inclined surface 9a, 9b, 9c of each branch 5a, 5b, 5c by a slot 7a, 7b, 7c.

The shape of the interface surface can vary.

According to the first embodiment of the set 40 of electrical contacts 1, 2, illustrated in FIGS. 2, 3 and 4, the interface surface 19b, 19c, 19a of each branch 5b, 5c, 5a adjacent to a given branch 5a, 5b, 5c of the first contact 1 respectively comprises an inclined surface 21b, 21c, 21a extending parallel to the inclined surface 9a, 9b, 9c of said given branch 5a, 5b, 5c.

According to this embodiment, the interface surface 19b, 19c, 19a of each branch 5b, 5c, 5a adjacent to a given branch 5a, 5b, 5c respectively comprises a portion 23b, 23c, 23a extending in a plane parallel to the axis of movement A, each of said portions 23b, 23c, 23a respectively extending the inclined surface 21b, 21c, 21a.

Likewise, in the example in FIG. 2, the interface surface 20b of the branch 6b adjacent to the branch 6a of the second contact 2 comprises an inclined surface 22b extending parallel to the inclined surface 10 of the branch 6a.

The interface surface 20b of the branch 6b adjacent to the branch 6a of the second contact 2 comprises a portion 24b extending in a plane parallel to the axis of movement A, the portion 24b extending the inclined surface 22b.

Each inclined surface 21b, 21c, 21a extending parallel to the inclined surface 9a, 9b, 9c of a branch 5a, 5b, 5c is respectively extended by a portion 23b, 23c, 23a extending in a plane parallel to the axis of movement A and forming a radial plane of the disc.

In the variant of the first embodiment illustrated in FIG. 4, the interface surface 19b, 19c, 19a of each branch 5b, 5c, 5a adjacent to a given branch 5a, 5b, 5c has the same shape as in the first embodiment.

According to the second embodiment, and as illustrated in FIG. 11 and FIG. 9, the interface surface 19b, 19c, 19a of each branch 5b, 5c, 5a adjacent to a given branch 5a, 5b, 5c respectively comprises a first portion 25b, 25c, 25a extending in a plane R1b, R1c, R1a parallel to the axis of movement A.

Each plane of extension R1b, R1c, R1a of the first portion 25b, 25c, 25a forms a radial plane of the disc.

FIG. 9 shows the radial nature of the respective plane of extension R1b, R1c, R1d, R1a of each first portion 25b, 25c, 25d, 25a, which passes through the centre C1 of the disc.

According to one variant embodiment, illustrated in particular in FIG. 13, each plane of extension R1b, R1c, R1a of the first portion 25b, 25c, 25a can respectively be parallel to a radial plane of the disc, and the distance j between each plane of extension R1b, R1c, R1a of the first portion 25b, 25c, 25a and the centre C1 of the disc is less than 10% of the diameter fi of the disc.

This variant is illustrated in FIG. 13, which shows the second contact 2.

Each plane of extension R2b, R2c, R2a of the first portion 26b, 26c, 26a of the second contact 2 is thus respectively parallel to a radial plane of the disc, and the distance j between each plane of extension R2b, R2c, R2a of the first portion 26b, 26c, 26a and the centre C2 of the disc is less than 10% of the diameter of the disc.

In other words, each plane of extension of the first portion is offset relative to the centre of the disc.

As illustrated in FIG. 10, the thickness E25 of each first portion 25b, 25c, 25a of the interface surface 19b, 19c, 19a is between 10% and 50% of the thickness E of the first contact 1.

The thickness of each first portion 25b, 25c, 25a of the interface surface 19b, 19c, 19a is measured along a direction parallel to the axis of movement A.

According to this embodiment, the interface surface 19b, 19c, 19a of each branch 5b, 5c, 5a adjacent to a given branch 5a, 5b, 5c respectively comprises a second portion 27b, 27c, 27a extending in a plane R2b, R2c, R2a parallel to the axis of movement A.

As illustrated in FIG. 9, each plane of extension R2b, R2c, R2a of the second portion 27b, 27c, 27a is respectively parallel to the plane of extension R1b, R1c, R1a of the first portion 25b, 25c, 25a.

The thickness E27 of each second portion 27b, 27c, 27a of the interface surface 19b, 19c, 19a can be between 50% and 90% of the thickness of the first contact 1.

A distance L1, measured along an orthoradial direction Tb, Tc, Ta, between the first portion 25b, 25c, 25a of the interface surface 19b, 19c, 19a and the second portion 27b, 27c, 27a of the interface surface 19b, 19c, 19a, is between 30% and 60% of the thickness E of the first contact 1.

The distance L1, shown in FIGS. 10 and 11, denotes the length of the third portion 29b, 29c, 29a measured along an orthoradial direction Tb, Tc, Ta. This distance corresponds to the free space, in a direction orthoradial to the disc, between the end of the portion of constant thickness of a branch and the edge of the adjacent branch.

A distance L2, measured along a direction parallel to the axis of movement A, between the portion 17a, 17b, 17c of constant thickness of a branch 5a, 5b, 5c and the first portion 25b, 25c, 25a of the interface surface 19b, 19c, 19a of an adjacent branch, is between 25% and 65% of the thickness E of the first contact 1.

The distance L2 is greater than or equal to 3 millimetres.

This distance L2 corresponds to the free space, in a direction parallel to the axis A, between the end of the portion of constant thickness of a branch and the edge of the adjacent branch.

According to this embodiment of the set 40 of electrical contacts, the interface surface 19b, 19c, 19a of each branch 5b, 5c, 5a adjacent to a given branch 5a, 5b, 5c respectively comprises a third portion 29b, 29c, 29a connecting the second portion 27b, 27c, 27a and the first portion 25b, 25c, 25a, the third portion 29b, 29c, 29a extending in a plane perpendicular to the axis of movement A.

FIG. 14 schematically shows a third embodiment, which differs from the first embodiment and the second embodiment in the shape of the interface surface.

According to this third embodiment of the set of contacts:
the inclined surface 9a, 9b, 9c of each branch 5a, 5b, 5c of the first contact 1 extends from a first axial surface of the disc to a second axial surface of the disc, and
the inclined surface 21b, 21c, 21a of the interface surface 19b, 19c, 19a of a branch 5b, 5c, 5a adjacent to a given branch 5a, 5b, 5c extends from a first axial surface of the disc to a second axial surface of the disc.

According to this embodiment, the inclined surface 9a, 9b, 9c of each branch 5a, 5b, 5c of the first contact 1 and the inclined surface 21b, 21c, 21a of the interface surface 19b, 19c, 19a of each branch 5b, 5c, 5a adjacent to a given branch 5a, 5b, 5c are parallel to each other.

In this figure, reference sign 10a denotes the inclined surface of the branch 6a of the second contact 2, and reference sign 20b denotes the interface surface of the branch 6b, this branch 6b being adjacent to the branch 6a.

The dimensions of the contacts 1, 2 and of the electrical current conducting stems 31, 32 can vary depending on the desired application.

The diameter of the electrical current conducting stems 31, 32 is between 10 millimetres and 100 millimetres.

The diameter of the first contact 1 and of the second contact 2 is between 20 millimetres and 100 millimetres.

The thickness E of the first contact 1 and of the second contact 2 is between 3 millimetres and 30 millimetres.

A method will now be described for manufacturing a contact of the set of electrical switching contacts as described above.

The manufacturing method comprises the steps of:
providing a blank contact having the shape of a disc comprising a first axial face and a second axial face on the opposite side from the first axial face,
machining the first axial face of the blank contact so as to form a set of first grooves at least partially crossing the thickness of the blank contact,
machining the second axial face of the blank contact so as to form a set of second grooves at least partially crossing the thickness of the blank contact and emerging in the first grooves, so as to form the slots separating the different branches of the contact.

The machining tool can be a cylindrical cutter.

The axis of rotation of the machining tool is parallel to the axis of the disc, therefore perpendicular to the axial surfaces of the disc.

The contact can for example be turned over after the machining of the set of first grooves, so that the machining has access to the second face of the blank contact.

Two different machining tools can also be used. A first tool moves in a first direction in order to remove material from the first axial face of the blank contact. A second tool moves in a second direction opposite to the first direction in order to remove material from the second axial face of the blank contact.

If contacts according to the second embodiment described are being manufactured, the machining of the set of first grooves makes it possible to form the first portion 25 of the branches and the portion 17 of constant thickness.

The machining of the set of second grooves makes it possible to form the second portion 27, the third portion 29, and the end 11 of the branches.

On the machining of the set of first slots, the lateral surface of the machining tool forms, during the movement thereof, the first portion 25 of each of the branches. The axial surface of the machining tool forms, during the movement thereof, the portion 17 of constant thickness.

On the machining of the set of second slots, the lateral surface of the machining tool forms, during the movement thereof, the second portion 27 and the end 11 of the branches. The axial surface of the machining tool forms, during the movement thereof, the third portion 29.

The manufacturing method comprises the step of:
machining the first axial face of the blank contact so as to form the inclined surfaces of the branches of the contact.

The inclined surfaces are formed by successive passes of the machining tool. Each pass is offset in an orthoradial direction relative to the previous pass, and the quantity of material removed increases on each pass in order to form the inclined surfaces.

In the case of the third embodiment, schematically illustrated in FIG. 14, the manufacturing method can comprise the step of:
machining part of the lateral surface of the blank contact so as to form the inclined surfaces of the branches of the contact.

A cylindrical cutter can for example be used. The axis of rotation of the machining tool is therefore perpendicular to the axis A of the disc.

The contacts 1, 2 can also be obtained by other manufacturing methods.

The contacts 1, 2 can for example be obtained by moulding. The slots of the contacts correspond to mould areas in which no material is present.

The contacts 1, 2 can also be obtained by single-axis compression and sintering.

According to another variant, the contacts 1, 2 can also be obtained by additive manufacturing.

1. A set (40) of electrical switching contacts (1, 2), in particular radial magnetic field contacts, for a vacuum breaker (100), the set (40) comprising:
a first contact (1) comprising a bearing surface (3) configured to be fastened to a first electrical current conducting stem (31), and
a second contact (2) configured to be moved along an axis of movement (A) between an open position (O) and a closed position (F), the second contact (2) comprising a bearing surface (4) configured to be fastened to a second electrical current conducting stem (32),
wherein each contact (1, 2) has the shape of a disc comprising a set of branches (5a, 5b, 5c; 6a, 6b, 6c), each branch (5a, 5b, 5c; 6a, 6b, 6c) being separated from an adjacent branch by a slot (7a, 7b, 7b; 8a, 8b, 8c) crossing the thickness of the disc, each slot (7a, 7b, 7b; 8a, 8b, 8c) extending radially from a lateral surface (33, 34) of the disc towards the inside of the disc,
wherein each branch (5a, 5b, 5c) of the first contact (1) comprises an inclined surface (9a, 9b, 9c) oriented in the opposite direction to the bearing surface (3) of the first stem (31),
wherein each branch (6a, 6b, 6c) of the second contact (2) comprises an inclined surface (10a, 10b, 10c) oriented in the opposite direction to the bearing surface (4) of the second stem (32),
and wherein the first contact (1) and the second contact (2) are angularly linked so that:
the slots (7a, 7b, 7c) of the first contact (1) coincide with the slots (8a, 8b, 8c) of the second contact (2) along a direction parallel to the axis of movement (A), and
the inclined surfaces (9a, 9b, 9c) of the branches (5a, 5b, 5c) of the first contact (1) and the inclined surfaces (10a, 10b, 10c) of the branches (6a, 6b, 6c) of the second contact (2) are opposite to each other along a direction parallel to the axis of movement (A).

2. The set (40) according to claim 1, wherein each branch (5a, 5b, 5c) of the first contact (1) respectively comprises a first end (11a, 11b, 11c) adjacent to a lateral surface (33) of the disc, and the first end (11a, 11b, 11c) of each branch (5a, 5b, 5c) is respectively opposite to an edge (15a, 15b, 15c) of an adjacent branch (5b, 5c, 5a) along a direction (D3) parallel to the axis of movement (A).

3. The set (40) according to claim 1, wherein the first contact (1) and the second contact (2) are symmetrical to each other relative to a plane perpendicular to the axis of movement (A).

4. The set (40) according to claim 2, wherein a straight line (D2) perpendicular to the inclined surface (9a, 9b, 9c) of each branch (5a, 5b, 5c) of the first contact (1) respectively forms an angle (a) of between 10° and 80° with a direction (D1) parallel to the axis of movement (A).

5. The set (40) according to claim 2, wherein the first end (11a, 11b, 11c) of each branch (5a, 5b, 5c) of the first contact (1) has the shape of a semi-cylinder extending along an axis parallel to the axis of movement (A).

6. The set (40) according to claim 1, wherein the inclined surface (9a, 9b, 9c) of each branch (5a, 5b, 5c) of the first contact (1) is respectively extended by a portion (17a, 17b, 17c) of constant thickness,
the portion (17a, 17b, 17c) of constant thickness extending in a plane (H) perpendicular to the axis of movement (A).

7. The set (40) according to claim 1, wherein the inclined surface (9a, 9b, 9c) of each branch (5a, 5b, 5c) of the first contact (1) is respectively opposite to an inner surface (19b, 19c, 19a) of an adjacent branch (5b, 5c, 5a), referred to as the interface surface, along a direction (D4a, D4b, D4c) parallel to an orthoradial direction (Ta, Tb, Tc) of the disc.

8. The set (40) according to claim 7, wherein the interface surface (19b, 19c, 19a) of each branch (5b, 5c, 5a) adjacent to a given branch (5a, 5b, 5c) of the first contact (1) respectively comprises an inclined surface (21b, 21c, 21a) extending parallel to the inclined surface (9a, 9b, 9c) of said given branch (5a, 5b, 5c).

9. The set (40) according to claim 8, wherein:
the inclined surface (9a, 9b, 9c) of each branch (5a, 5b, 5c) of the first contact (1) extends from a first axial surface of the disc to a second axial surface of the disc, and
the inclined surface (21b, 21c, 21a) of the interface surface (19b, 19c, 19a) of a branch (5b, 5c, 5a) adjacent to a given branch (5a, 5b, 5c) extends from a first axial surface of the disc to a second axial surface of the disc.

10. The set (40) according to claim 9, wherein the inclined surface (9a, 9b, 9c) of each branch (5a, 5b, 5c) of the first contact (1) and the inclined surface (21b, 21c, 21a) of the interface surface (19b, 19c, 19a) of each branch (5b, 5c, 5a) adjacent to a given branch (5a, 5b, 5c) are parallel to each other.

11. The set (40) according to claim 8, wherein the interface surface (19b, 19c, 19a) of each branch (5b, 5c, 5a) adjacent to a given branch (5a, 5b, 5c) respectively comprises a portion (23b, 23c, 23a) extending in a plane parallel to the axis of movement (A), each of said portions (23b, 23c, 23a) respectively extending the inclined surface (21b, 21c, 21a).

12. The set (40) according to claim 7, wherein the interface surface (19b, 19c, 19a) of each branch (5b, 5c, 5a) adjacent to a given branch (5a, 5b, 5c) respectively comprises a first portion (25b, 25c, 25a) extending in a plane (R1b, R1c, R1a) parallel to the axis of movement (A), each plane of extension (R1b, R1c, R1a) of the first portion (25b, 25c, 25a) forming a radial plane of the disc.

13. The set (40) according to claim 12, wherein the interface surface (19b, 19c, 19a) of each branch (5b, 5c, 5a) adjacent to a given branch (5a, 5b, 5c) respectively comprises a second portion (27b, 27c, 27a) extending in a plane (R2b, R2c, R2a) parallel to the axis of movement (A).

14. The set (40) according to claim 13, wherein each plane of extension (R2b, R2c, R2a) of the second portion (27b, 27c, 27a) is respectively parallel to the plane of extension (R1b, R1c, R1a) of the first portion (25b, 25c, 25a).

15. The set (40) according to claim 13, wherein the interface surface (19b, 19c, 19a) of each branch (5b, 5c, 5a) adjacent to a given branch (5a, 5b, 5c) respectively comprises a third portion (29b, 29c, 29a) connecting the second portion (27b, 27c, 27a) and the first portion (25b, 25c, 25a), the third portion (29b, 29c, 29a) extending in a plane perpendicular to the axis of movement (A).

16. (canceled)

17. (canceled)

18. (canceled)

19. A vacuum breaker (100) comprising:
an envelope (80), the envelop forming a sealed enclosure under vacuum,
a first contact (1) within the envelope (80), the first contact comprising a bearing surface (3) configured to be fastened to a first electrical current conducting stem (31),
a second contact (2) within the envelope (80), the second contact configured to be moved along an axis of movement (A) between an open position (O) and a closed position (F), the second contact (2) comprising a bearing surface (4) configured to be fastened to a second electrical current conducting stem (32),
wherein each contact (1, 2) has the shape of a disc comprising a set of branches (5a, 5b, 5c; 6a, 6b, 6c), each branch (5a, 5b, 5c; 6a, 6b, 6c) being separated from an adjacent branch by a slot (7a, 7b, 7b; 8a, 8b, 8c) crossing the thickness of the disc, each slot (7a, 7b, 7b; 8a, 8b, 8c) extending radially from a lateral surface (33, 34) of the disc towards the inside of the disc,
wherein each branch (5a, 5b, 5c) of the first contact (1) comprises an inclined surface (9a, 9b, 9c) oriented in the opposite direction to the bearing surface (3) of the first stem (31),
wherein each branch (6a, 6b, 6c) of the second contact (2) comprises an inclined surface (10a, 10b, 10c) oriented in the opposite direction to the bearing surface (4) of the second stem (32),
and wherein the first contact (1) and the second contact (2) are angularly linked so that:
the slots (7a, 7b, 7c) of the first contact (1) coincide with the slots (8a, 8b, 8c) of the second contact (2) along a direction parallel to the axis of movement (A), and
the inclined surfaces (9a, 9b, 9c) of the branches (5a, 5b, 5c) of the first contact (1) and the inclined surfaces (10a, 10b, 10c) of the branches (6a, 6b, 6c) of the second contact (2) are opposite to each other along a direction parallel to the axis of movement (A).

20. The vacuum breaker (100) according to claim 19, further comprising the second contact (2) being movable between a position (F) in contact with the first contact (1) that allows the passage of electrical current in the vacuum breaker (100) and a position (O) separated from the first contact (1) that prohibits the passage of current in the vacuum breaker (100).

21. The vacuum breaker (100) according to claim 19, further comprising the two contacts (1, 2) being configured to be moved in opposite directions along an axis of movement (A) between a closed position (F) that allows the passage of electrical current in the vacuum breaker (100) and an open position (O) that prohibits the passage of current in the vacuum breaker (100).

22. The vacuum breaker (100) according to claim 19, further comprising the first contact (1) being in a fixed position within the envelope (80) and the second contact (2) being configured to move translationally relative to the envelope (80) between an open position (O) and a closed position (F).

23. A switching device comprising:
one or more conductors, each conductor comprising a vacuum breaker, wherein the vacuum breaker comprises:
an envelope (80), the envelop forming a sealed enclosure under vacuum,
a first contact (1) within the envelope (80), the first contact comprising a bearing surface (3) configured to be fastened to a first electrical current conducting stem (31),
a second contact (2) within the envelope (80), the second contact configured to be moved along an axis of movement (A) between an open position (O) and a closed position (F), the second contact (2) comprising a bearing surface (4) configured to be fastened to a second electrical current conducting stem (32),
the two contacts (1, 2) being configured to be moved in opposite directions along an axis of movement (A) between a closed position (F) that allows the passage of electrical current in the vacuum breaker (100) and an open position (O) that prohibits the passage of current in the vacuum breaker (100),
wherein each contact (1, 2) has the shape of a disc comprising a set of branches (5a, 5b, 5c; 6a, 6b, 6c), each branch (5a, 5b, 5c; 6a, 6b, 6c) being separated from an adjacent branch by a slot (7a, 7b, 7b; 8a, 8b, 8c) crossing the thickness of the disc, each slot (7a, 7b, 7b; 8a, 8b, 8c) extending radially from a lateral surface (33, 34) of the disc towards the inside of the disc,
wherein each branch (5a, 5b, 5c) of the first contact (1) comprises an inclined surface (9a, 9b, 9c) oriented in the opposite direction to the bearing surface (3) of the first stem (31),
wherein each branch (6a, 6b, 6c) of the second contact (2) comprises an inclined surface (10a, 10b, 10c) oriented in the opposite direction to the bearing surface (4) of the second stem (32),
and wherein the first contact (1) and the second contact (2) are angularly linked so that:
the slots (7a, 7b, 7c) of the first contact (1) coincide with the slots (8a, 8b, 8c) of the second contact (2) along a direction parallel to the axis of movement (A), and
the inclined surfaces (9a, 9b, 9c) of the branches (5a, 5b, 5c) of the first contact (1) and the inclined surfaces (10a, 10b, 10c) of the branches (6a, 6b, 6c) of the second contact (2) are opposite to each other along a direction parallel to the axis of movement (A).
